(19) United States
(12) Patent Application Publication
(10) Pub. No.: US 2005/0229867 A1
(43) Pub. Date: Oct. 20, 2005

(54) Belt with universal leash holder and quick-release

(76) Inventor: Brian J. Green, Denver, CO (US)

Correspondence Address: Donald W. Meeker, #512, 750 La Playa, San Francisco, CA, 94121, US

(21) Appl. No.: 10/128,114

(22) Filed: Apr. 22, 2002

(51) Int. Cl. B60R 22/12; B60R 22/00; A62B 35/00

(52) U.S. Cl. 119/770

(57) ABSTRACT

A double belt has an outer narrow belt completely encircling and extending over and attached to the ends of an inner wider belt. The outer belt adjustably attaches to a quick release buckle at the ends to create an adjustable inner belt attachable to a body of a user or tree or other object. The outer belt has another quick release buckle in the portion overlapping the inner belt. A fabric loop with two metal rings encircling the outer belt attaches through the end loop or handle of any leash to ride on the rings around the outer belt.

### BACKGROUND OF THE INVENTION

1. Field of the Invention

The present invention relates to restraint lines or leashes and in particular to a belt to be worn around the waist of a person or attached around a tree or other secure upright, the belt having an encircling track and universal leash connector for receiving any type of restraint line or leash including a retractable handle with a leash, allowing the animal or child on the leash to encircle the belt, and further having a quick release mechanism to release the leash when necessary: thus providing a hands-free belt for holding a leash to be used while walking or jogging.

2. Description of the Prior Art

Often people jog or walk with their animals or young children and normally the animals are required to be on a leash and parents sometimes use a harness and leash on children for safety reasons, such as preventing the child from running out into traffic or becoming lost during a crowded event.

Having the hands free for normal swinging of the arms during walking or jogging is a natural and healthful way to exercise. Also, if a person is carrying items such as shopping bags, it is very difficult to also be holding a leash or restraint line with something moving at the other end.

Many attempts have been made to provide a hands-free leash holding belt. But they fall short of full applicability for any type of leash, including the retractable handle leashes very popular today.

U.S. Pat. No. 5,950,569, issued Sep. 14, 1999 to Perrulli, provides a belt having an overlapping second belt portion half way around the belt. A ring encircles the overlapping belt portion and a dog leash is hooked onto the ring.

U.S. Pat. No. 6,192,835, issued Feb. 27, 2001 to Calhoun, shows a thick belt with two loops attached that presumably slide around the thick belt. Quick release attachments connect the dog leash with the loop on the belt. Having two loops enables both ends of the dog leash to be attached to the belt for storing the leash on the belt.

U.S. Pat. No. 5,718,189, issued Feb. 17, 1998 to Blake, claims a belt having two non-moving loops built in for attaching the leash and a handle portion for holding the belt and leash with the belt removed from the wearer.

U.S. Pat. No. 5,161,486, issued Nov. 10, 1992 to Brown, describes a belt having two rings attached with a loose strap attached between the rings and the dog leash attached to a ring which slides on the loose strap.

U.S. Pat. No. 5,080,045, issued Jan. 14, 1992 to Reese, discloses a belt having an attached ring encircling the body with a sliding element moving within the ring and the dog leash attached to the sliding element. This would be cumbersome and expensive.

U.S. Pat. No. 4,945,861, issued Aug. 7, 1990 to de Koning, indicates a hook which attaches to a regular belt and the dog leash attaches to the hook.

U.S. Pat. No. 3,721,216, issued Mar. 20, 1973 to Lippe, puts forth a belt having an encircling track with a slot and a slider slides in the track with the dog leash attached to the slider.

U.S. Pat. No. #Des. 350,628, issued Sep. 13, 1994 to Williams, concerns a fabric belt with a fabric leash attached by a loop to the belt.

U.S. Pat. No. #Des. 408,598, issued Apr. 20, 1999 to Martell, illustrates a belt having an additional overlapping belt attached part way around the belt with rings on the overlapping belt to attach the leash and also includes a zippered pocket for storing the leash.

U.S. Pat. No. 5,038,719, issued Aug. 13, 1991 to McDonough, is for a belt having a leash secured by an adjustable slide and an additional hook for shortening the leash by attaching it part way along its length to the hook.

Most of the prior art patents require a unique leash to be sold with the belt. None provide a belt with a universal holder to fit any sized or type of existing leash including a handle with a retractable dog leash. Many of the prior art devices would produce discomfort to the wearer of the belt due to the difficulty of movement of the leash attaching means to the belt.

### SUMMARY OF THE INVENTION

An object of the present invention is to provide a belt with a universal leash holder to hold any type of leash including a retractable handle with a leash by having a loop of material which can engage any type of leash with the loop slidably connected to the tracking belt by a ring at each end of the loop which slide easily on the tracking belt.

Another object of the present invention is to provide a double belt leash holding belt with a loose fit leash tracking belt that completely encircles the user on the outside of the belt attached to the user from both sides of the buckle and provide easy sliding D-rings or other rings interconnecting a holding loop that slides easily around the waist of the user for total comfort.

A related object of the present invention is to provide 360° runaround capability by having the tracking belt attached immediately adjacent to the belt buckle of the main wide belt attached to the user so that the tracking belt completely encircles the user. When the leash reaches the end of the track with the pet or child heading around in a complete circle, the user simply pivots around in a circle in the same direction as the encircling pet or child, bringing the leash attachment to the beginning of the tracking belt on the opposite side of the buckle enabling the pet or child to continue running in a complete circle.

One more object of the present invention is to provide a quick release snap open buckle on the tracking belt so that the leash may be released instantly in case of emergency.

An additional object of the present invention is to provide a leash belt which is easy and inexpensive to make using wide webbing for the user belt and narrower webbing for the tracking belt with the tracking belt webbing being sewn or otherwise attached at the very ends of the wide belt and the tracking belt continuing to connect to the snap plastic buckle or other connecting means that secures the wide belt securely around the waist of the user.

A further object of the present invention is to provide a leash belt that will fit all sizes of users by providing extra long tracking webbing which is adjustably slid into the buckle, and the same tracking webbing slid adjustably into the quick release buckle with an overlap for adjustability.

A contributory object of the present invention is to provide a highly luminous reflective safety coating to the outside of the tracking belt for safety during nighttime use.

In brief, a wide belt fits adjustably around the waist of the wearer. This belt can also be fit adjustably around a tree or other secure objects to secure a pet or child temporarily to the tree or other object while still permitting the pet or child to encircle the tree or object.

The outer tracking belt is a narrower strip of webbing attached to the wide belt by sewn or rivets or other means only at the ends of the wide belt so that the tracking webbing not only encircles the wide belt for its entire length but also continues on to connect to the buckle. One connection of the tracking webbing to the buckle allows the webbing to overlap itself and provide adjustability with the buckle movable along the tracking belt between the ends of the wide belt, thereby making the wide belt adjustable around the waist of the user. The tracking belt also is attached to a quick release buckle (preferably a plastic snap buckle) on the tracking portion overlapping the wide belt. The same type and size of buckle may be used for attaching the wide belt to the user and for the quick release buckle on the tracking belt where it overlaps the wide belt, thereby saving costs of materials. The tracking belt may be adjustably attached to the quick release buckle to allow the user to adjust the tension of the tracking belt for easier or more restricted movement of the pet or child around the belt.

A universal attaching means comprises a loop of material having a D-ring or other metal ring at each end attached to the tracking belt to easily move along the tracking belt. Any type of dog leash, including a dog leash with a hand loop at the end and a retractable dog leash handle, can fit on the loop by releasing one of the loops from the tracking belt at the quick release buckle, inserting the loop through the end of the leash or the retractable handle and reattaching the loop to the tracking belt.

360° encircling of the user by the pet or child is possible by having the user pivot around in place in the same direction as the encircling pet or child when the leash reaches one end of the tracking belt, thereby moving the end of the leash to the other end of the tracking belt and enabling the pet or child to continue circling.

An advantage of the present invention is hands free restraint of a pet or child to enable walking or jogging normally or carrying things or other activity with hands free.

Another advantage of the present invention is that it can be used with any leash or restraining line.

An additional advantage of the present invention is that it allows instant release of the leash in an emergency.

One more advantage of the present invention is that it is easy and inexpensive to produce.

### BRIEF DESCRIPTION OF THE DRAWINGS

These and other details of my invention will be described in connection with the accompanying drawings, which are furnished only by way of illustration and not in limitation of the invention, and in which drawings:

FIG. 1 is a perspective view of the invention showing all of the features and two possible types of leashes which may be used with the invention.

### BEST MODE FOR CARRYING OUT THE INVENTION

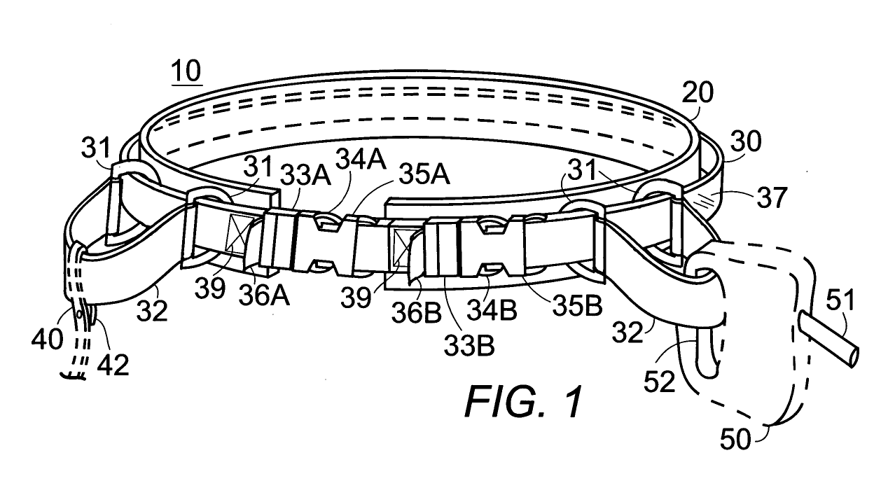

In FIG. 1, a leash holding belt 10 for use with any type of leash and restraint line comprises a first wide belt 20 having two ends and an inner surface and an outer surface, the first belt being capable of encircling a body of a user and other desired structures with the inner surface in contact with the body of the user or other structures such as a tree, a second belt 30 encircling the first belt on the outer surface, the second belt connected to the first belt 20 by sewing 39, rivets or other means adjacent to the two ends of the first belt, and a leash connecting means 32 slidably attached to the second belt 30, the leash connecting means being capable of attaching to any desired leash and restraint line, such as a traditional leash 40 with a holding loop 42 or a retractable holder 50 for a leash 51 with a handle opening 52.

The leash connecting means comprises a loop of flexible material 32 capable of fitting within an end of any leash, such as the hand loop 42 or the handle 52 and restraint line and retaining the leash and restraint line, the loop of flexible material having a ring 31 of rigid material at each end, the ring of rigid material capable of encircling and sliding along the second belt 30 along its length for a universal slidable leash holder.

The second belt comprises two sections of elongated material interconnected by an interconnecting means, such as a quick release plastic buckle having two ends 33B and 35B with a snap-fit tab 34B, which is capable of being quickly disconnected. The second belt may be adjustably connected to the plastic quick release buckle with one end having an adjustable overhang 36B frictionally looped through one side 33B of the buckle.

The second belt 30 has two ends which each extend beyond the end of the first belt 20 and each connect to a means of releasably interconnecting the two ends of the first belt, such as an identical plastic quick release buckle with ends 33A and 35A and a snap fit tab 34A. At least one end of the second belt is adjustably attached to the means of releasably interconnecting the two ends of the first belt with one end having an adjustable overhang 36A frictionally looped through one side 33A of the buckle, so that the length of the first belt is adjustable.

The second belt 30 further comprises a highly reflective outer surface 37.

It is understood that the preceding description is given merely by way of illustration and not in limitation of the invention and that various modifications may be made thereto without departing from the spirit of the invention as claimed.

1. A leash holding belt for use with any type of leash and restraint line, the belt comprising:
a first belt having two ends and an inner surface and an outer surface, the first belt adapted for encircling a body of a user and other desired structures with the inner surface in contact therewith;
a second belt encircling the first belt on the outer surface, the second belt connected to the first belt adjacent to the two ends of the first belt, the second belt comprising two ends which each extend beyond one of the two ends of the first belt and each connect to a means of releasably interconnecting the two ends of the first belt, at least one end of the second belt being adjustably attached to the means of releasably interconnecting the two ends of the first belt so that the length of the first belt is adjustable;
a leash connecting means slidably attached to the second belt, the leash connecting means attachable to any desired leash and restraint line.

2. The leash holding belt of claim 1 wherein the leash connecting means comprises a loop of flexible material adapted for fitting within an end of any leash and restraint line and retaining the leash and restraint line, the loop of flexible material having a ring of rigid material at each end, the ring of rigid material adapted for encircling and sliding along the second belt along its length.

3. The leash holding belt of claim 1 wherein the second belt comprises two sections of elongated material interconnected by an interconnecting means which is adapted for being quickly disconnected.

4. The leash holding belt of claim 3 wherein the interconnecting means comprises a quick release buckle.

5. The leash holding belt of claim 4 wherein the quick release buckle comprises a snap-fit plastic buckle.

6. (canceled)

7. The leash holding belt of claims 1 wherein the means of releasably interconnecting the two ends of the first belt comprises a snap-fit plastic buckle.

8. (canceled)

9. The leash holding belt of claim 1 wherein the second belt further comprises a highly reflective outer surface.
